(19) United States
(12) Patent Application Publication
(10) Pub. No.: US 2010/0176107 A1
(43) Pub. Date: Jul. 15, 2010

(54) SYSTEM AND METHOD FOR ELECTROSLAG WELDING SPLICED VERTICAL BOX COLUMNS

(76) Inventor: WILLIAM L. BONG, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/352,297

(22) Filed: Jan. 12, 2009

(51) Int. Cl. B23K 9/00

(52) U.S. Cl. 219/137 R; 219/136

(57) ABSTRACT

A system and method for welding spliced vertical box columns with an electroslag welding system. The system includes a welding fixture having opposing, paired and positionally adjustable welding shoes, run-off tabs, and sumps affixed at the junction of box columns to be spliced. A distributed control electroslag welding system, articulating boom, welding torch and consumable guide tube oscillator feed provide molten flux within the shoes filling from the sump to the run-off tab.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to a system and method for electroslag welding vertically aligned workpieces, in particular spliced vertical box columns.

### BACKGROUND OF THE INVENTION

My U.S. Pat. No. 6,297,472, issued Oct. 2, 2001, discloses and claims a welding system and method including a distributed welding control system that allows a welding operator to program automated welding cycles for various welding operations, and that is particularly useful for installing stiffener plates onto structural beams. In U.S. Pat. No. 6,297,472, the welding system includes a welding fixture with a pair of opposing, positionally adjustable welding shoes, and lock screws for attaching a workpiece such as an I-beam. A rotary straight wire feeder removes the cant and helix from welding wire as it is fed to the welding torch. The welding torch is attached to the power cables coming from the welding power supply and is a receptacle for the consumable guide tube. Wire feed conduits are attached to the wire feeder on one end and the welding torch on the other. During the welding operation, welding wire is feed from the wire feeder, through the wire feed conduits to the welding torch. The wire then travels through the welding torch to the consumable guide tube and is attached to the output of the welding torch. The consumable guide tube and the welding wire carry the welding current to the molten weld puddle at the bottom of the weld cavity.

My U.S. patent application Ser. No. 10/731,414, filed Dec. 9, 2003 and related U.S. Letters Pat. No. 7,429,716, discloses and claims a modular welding system for performing quick, easy and high quality welds. The modular welding system of application Ser. No. 10/731,414, and related U.S. Letters Pat. No. 7,429,716 issued Sep. 30, 2008, includes a basic component system and a modular fixture component system. The basic component system provides the basic components necessary to perform a quality weld efficiently. The modular component system interfaces with the basic component system and provides a particular welding fixture assembly that performs a particular type of weld. More particularly, a stiffener type modular component system and a butt/tee type modular system fixture system are disclosed and claimed. The modular welding system of application Ser. No. 10/731,414, and related U.S. Letters Pat. No. 7,429,716, easily may be integrated with the basic components of the system and method for electroslag welding spliced box columns for high-rise building fabrication and erection.

My U.S. Pat. No. 7,038,159, issued May 2, 2006, discloses and claims a system and method for electroslag butt-welding expansion joint rails comprising a distributed welding control system. The method includes defining a weld cavity with a first expansion joint rail, a second expansion joint rail, a plurality of gland shoes, and a pair of butt shoes, and can be adapted for welding an expansion joint rail to a support beam. The system and method of U.S. Pat. No. 7,038,159 easily may be integrated with the basic components of the system and method for electroslag welding spliced box columns for high-rise building fabrication and erection.

My U.S. Pat. No. 7,148,443, issued Dec. 12, 2006, discloses and claims a consumable guide tube including a thin first elongate strip, a second elongated strip, and a plurality of insulators. An embodiment of Pat. No. 7,148,443 includes a thin first elongate strip that is a low carbon cold-rolled steel strip, and a second elongated strip which is a low carbon hot-rolled steel strip. The guide tube of Pat. No. 7,148,443 can also be configured to include two or more longitudinal channels, and easily is adaptable to the system and method for electroslag welding spliced box columns for high-rise building fabrication and erection.

My U.S. patent application Ser. No. 11/591,190, filed Oct. 30, 2006, discloses and claims a consumable guide tube including a thin first elongate strip, a second elongated strip, and a plurality of insulator modules. An embodiment of application Ser. No. 11/591,190 includes a thin first elongate strip that has a front face and a back face. The front face has at least one longitudinal channel. The second elongated strip has is a front face and a back face and the front face is of the second elongated strip is configured to be coupled to the front face of the thin first elongated strip. A plurality of insulator modules are deposited on the back face of the thin first elongated strip and on the back face of the second elongated strip. Preferably, the thin first elongated strip is a low carbon cold rolled steel strip, and the second elongated strip is a low carbon hot rolled steel strip. The guide tube of application Ser. No. 11/591,190 can also be configured to include two or more longitudinal channels. The guide tube of U.S. patent application Ser. No. 11/591,190 can also be configured to include two or more longitudinal channels, and easily is adaptable to the system and method for electroslag welding spliced box columns for high-rise building fabrication and erection.

The following disclosure provides a system and method for electroslag welding vertically aligned work-pieces for structures with unlimited multiple floor levels, in particular spliced box columns. An embodiment includes a distributed control system having a plurality of controller modules and a common bus connecting each controller module. Each controller module includes at least one operator control panel module. The system includes at least one welding torch configured to receive at least one consumable guide tube that is placed into the welding cavity. The welding torch is coupled to the welding fixture adjacent to each centerline. The system also includes first and second elongated, parallel rotating shafts according to U.S. Letters Pat. No. 7,148,443 and pending U.S. Non-provisional Utility patent application Ser. No. 11/202,020, which are herein incorporated; first and second linear actuators according to U.S. Letters Pat. No. 7,148,443 and pending U.S. Non-provisional Utility patent application Ser. No. 10/731,414 and related U.S. Letters Pat. No. 7,429,716, which are herein incorporated. These actuators are movably mounted on the rotating shafts and include an assembly for longitudinally translating the linear actuators along the shafts as the shafts rotate according to U.S. Letters Pat. No. 7,148,443 and pending U.S. Non-provisional Utility patent application Ser. No. 10/731,414 and related U.S. Letters Pat. No. 7,429,716, which are herein incorporated. The system also includes an assembly for sensing movement of the linear actuators according to U.S. Letters Pat. No. 7,148,443 and pending U.S. Non-provisional Utility patent application Ser. No. 10/731,414 and related U.S. Letters Pat. No. 7,429,716, which are herein incorporated, and a protective housing assembly for enclosing the rotating shafts, the actuators, the longitudinally translating assembly, and the sensing assembly, for oscillating each welding torch with the cavity.

The welding system and method including a distributed welding control system allows the combination and use of features of my several above cited patents and/or patent applications, as more particularly incorporated and described herein, to allow a welding operator to program automated welding cycles for various welding operations, and is particularly useful for splicing vertical aligned structural box columns having an acute angle gap between the columns. A disclosed embodiment of the welding system and method includes a forty-five degree angle gap between the spliced box columns.

### DISCLOSURE OF INVENTION

My system and method for electroslag welding spliced vertical columns as disclosed in my pending U.S. Non-provisional patent application Ser. No. 12/212,019, filed Sep. 17, 2008 (the “'019 Application”), is incorporated herein for all purposes.

On-site erection of buildings is accomplished by stacking one vertical support column on top of another and welding the two stacked columns together. For spliced vertical columns, the bottom column flanges are cut square, and the web is generally beveled, FIGS. 6 and 7 of the '019 Application. The column that is stacked on top of the bottom column has the bottom of the flanges beveled at some acute angle (generally between 30-degrees to 60-degrees) to provide a welding surface to connect the two columns. The generally accepted practice for welding the top of the bottom column flange to the bottom of the top flange on an acute angle bevel, FIGS. 6 and 7 of the '019 Application. When the top column is set on top of the bottom column, a splicing plate is generally bolted to the two webs to hold the columns together so the installation crane can be removed. The column is generally squared with cables and “strong backs” are installed to hold the column in position while weld passes are made between the two column flanges and the two column webs to join them together.

The generally accepted practice is for welding the top of a bottom box column flange to the bottom of the top box column flange is an acute angle bevel, FIGS. 1-13. When the top box column is set on top of the bottom box column, splice plates and strong backs are generally attached to the two webs to hold the box columns together so the installation crane can be removed. The box column is generally squared with cables and weld passes are made between the two box column flanges and the two box column webs to join them together. Different building erection companies may use different methods or different sequences other than those described here, but the general description of how the two box columns are generally joined together with the multipass gas shielded, or gasless flux cored wire welding process, would not substantively deviate from the system and method described herein.

The thicker the box column flanges, the more weld passes that are needed to join the two box column flanges and column webs together. For box columns that are two inches thick, 16 man-hours to 30 man-hours are generally necessary to generate the number of weld passes to join the two flanges and two webs that make up a box column.

The system and method for electroslag welding spliced vertical box columns allows welding of the two flanges on the box column simultaneously and the two webs on the box column simultaneously. The typical welding time takes approximately 30 minutes to 45 minutes to weld the two flanges, and 30 minutes to 45 minutes to weld the two webs that make up the square box column. This rapid welding system and method can result in a building being welded much faster, allowing for completion and occupancy of the building in a much shorter time period than using multi-pass gas shielded or gasless flux cored wire welding processes.

The system and method for electroslag welding spliced vertical box columns is applicable to box beam column architecture for high-rise building fabrication and architecture.

The system and method for electroslag welding spliced vertical box columns is particularly suited to modular welding systems using distributed control for performing quick, easy and high quality welds.

Other features, advantages, and objects of the system and method for electroslag welding spliced vertical box columns will become apparent with reference to the following description and accompanying drawings.

These together with other objects of the system and method for electroslag welding spliced vertical box columns, along with the various features of novelty which characterize the invention, are described with particularity in the claims attached to and forming a part of this disclosure. For a better understanding of the system and method for electroslag welding spliced vertical box columns, its operating advantages and the specific objects attained by its uses, reference should be made to the attached drawings and descriptive materials in which there are illustrated preferred embodiments of the invention.

### BRIEF DESCRIPTION OF DRAWINGS

These and other features, aspects, and advantages of the system and method for electroslag welding spliced vertical box columns will become better understood with regard to the following description, appended claims, and accompanying drawings as further described.

FIG. 1 is a perspective view of apparatus for a system of electroslag welding for buildings 400 with unlimited multiple floor levels, wherein one pair of opposing welding shoes are placed on each side of a gap between one first vertically aligned box column workpiece and at least one second vertically aligned box column workpiece to form at least one welding cavity between the welding shoes. The inside shoe is made of steel and becomes part of the weld joint after the weld has been completed. The outside shoe is either water-cooled copper or air-cooled copper so that the copper shoe can be removed after the weld has been completed.

FIG. 2 is a perspective view of the box column plates. The two wider plates are referred to hereinafter as the box column “flange plates” and the two narrower plates are hereinafter referred to as the “web plates”. These two vertically aligned flange plates and the two vertically aligned web plates are makeup the structure of the box column. The flange plates are welded in pairs at the same time with the Arcmatic™ VertaSlag™ welding process. After the two flange plates have been welded, the web plates are also welded in pairs to complete the splicing of the box column. This welding method is used in buildings with unlimited multiple floor levels, with an acute angled gap between each separate vertically aligned spliced box column workpiece and releasable couplings which hold the spliced box column workpiece assembly together during the welding process.

FIG. 3 is also perspective view of electroslag welded spliced box column workpieces, used in buildings with unlimited multiple floor levels, conjoined along the acute angled gap.

FIG. 4 is a top perspective view of the spliced box column workpiece ends 500 and 510 of an embodiment of the system and method of electroslag welding spliced vertical box columns used in structures with unlimited multiple floor levels depicting a gap 620 oriented at a forty-five degree angle between the paired workpiece ends with the top end of the bottom column web 500 and the bottom end of the top column web 510 and vertical weld 650 is a weld that is performed in the shop that joins both longitudinal sides of the web to the two longitudinal flanges. These welds are performed in the shop prior to shipping the box column to the job site to be welded together with the proposed VertaSlag™ column splicing method. 660 is the opposite side web to the 510 web in each workpiece.

FIG. 5 is a top perspective view of the spliced box column workpiece where 500 is the bottom column flange on the right side of the box column and 510 is the top column flange on the right side of the box column. During the erection process for an embodiment of the system and method, the top box column is lowered by crane onto the steel backup bars on the inside of the box column. When the bottom of the top column comes to rest on the top of the bottom column backup bars, a ¾-inch gap 620 is formed between the two flanges, 500 and 510, and corresponding webs, 670 and 680, to form the 45-degree VertaSlag weld cavity. The embodiment of the system and method of electroslag welding splices vertical box columns used in structures with unlimited multiple floor levels depicting a gap 620 oriented at a forty-five degree angle between the paired flange workpiece ends 600 and 510 and corresponding webs, 670 and 680.

FIG. 6 is a front elevation view of the spliced box column workpiece flange ends, 500 and 510, and corresponding webs, 670 and 680, of FIG. 5.

FIG. 7 is a right elevation view of the spliced box column flange workpiece ends 500 and 510, and corresponding webs, 670 and 680, of FIG. 5.

FIG. 8 is a top planar view of the spliced box column flange workpiece end 510 and corresponding web 680 of FIG. 5.

FIG. 9 is a section view of the spliced box column flange workpiece ends, 500 and 510, and corresponding webs, 670 and 680, of FIG. 5.

FIG. 10 is an exploded perspective view of the spliced box column flange workpiece ends, 600 and 510, and corresponding webs, 670 and 680, of FIG. 5.

FIG. 11 is an exploded elevation view of the spliced box column flange workpiece ends, 500 and 510, and corresponding webs, 670 and 680, of FIG. 5.

FIG. 12 is an exploded elevation view of the spliced box column flange workpiece ends, 500 and 510, and corresponding webs, 670 and 680, of FIG. 5.

FIG. 13 is an exploded perspective view (assembly drawing) of an embodiment of the system 400 and method of electroslag welding spliced vertical box columns used in structures with unlimited multiple floor levels depicting a gap 620 oriented at a forty-five degree angle between the paired flange workpiece ends 500 and 510, and web plates 660 and 670 in each workpiece end, internal steel backup bar assemblies 700, and outside air-cooled, or water-cooled copper welding shoes 530, sumps 760, run-off tabs 770, and strong back assembly 720 for aligning the column and for holding the outside copper welding shoes 530, and for releasably coupling and securing the copper welding shoe pairs 530 during the welding operation for welding on each gap.

### BEST MODE FOR CARRYING OUT THE INVENTION

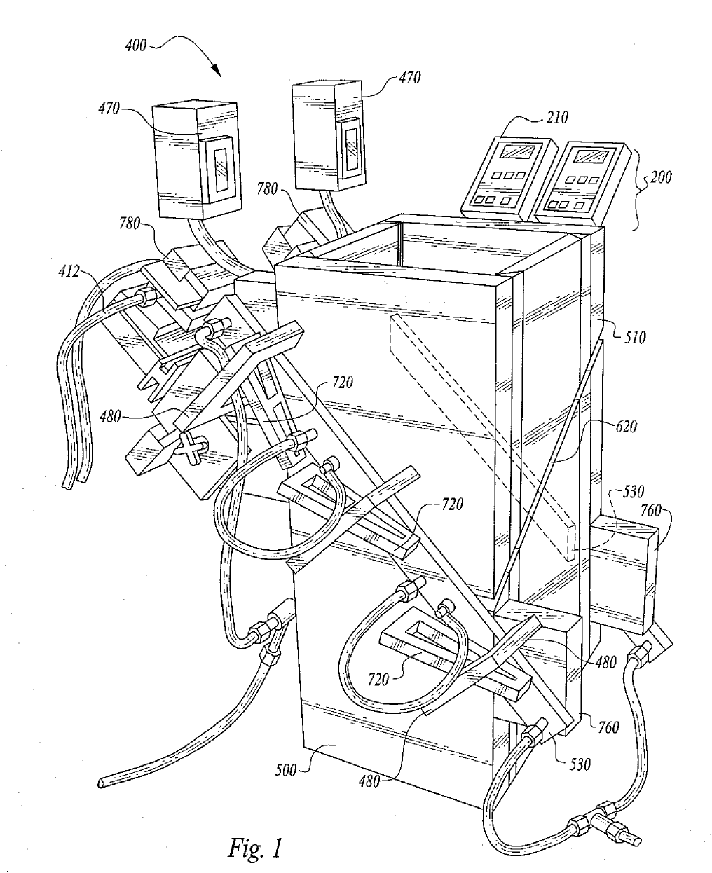

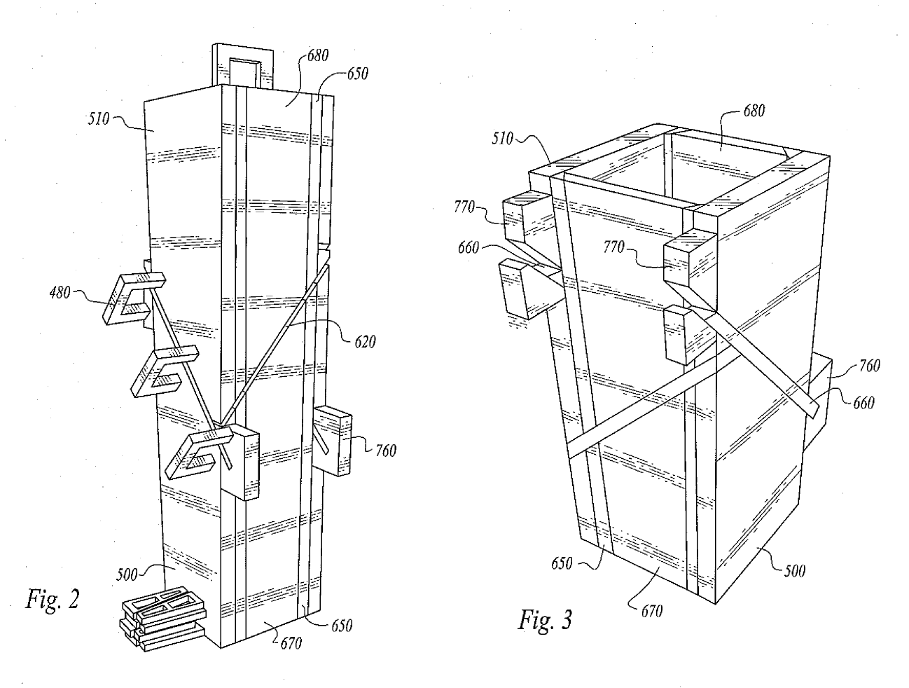

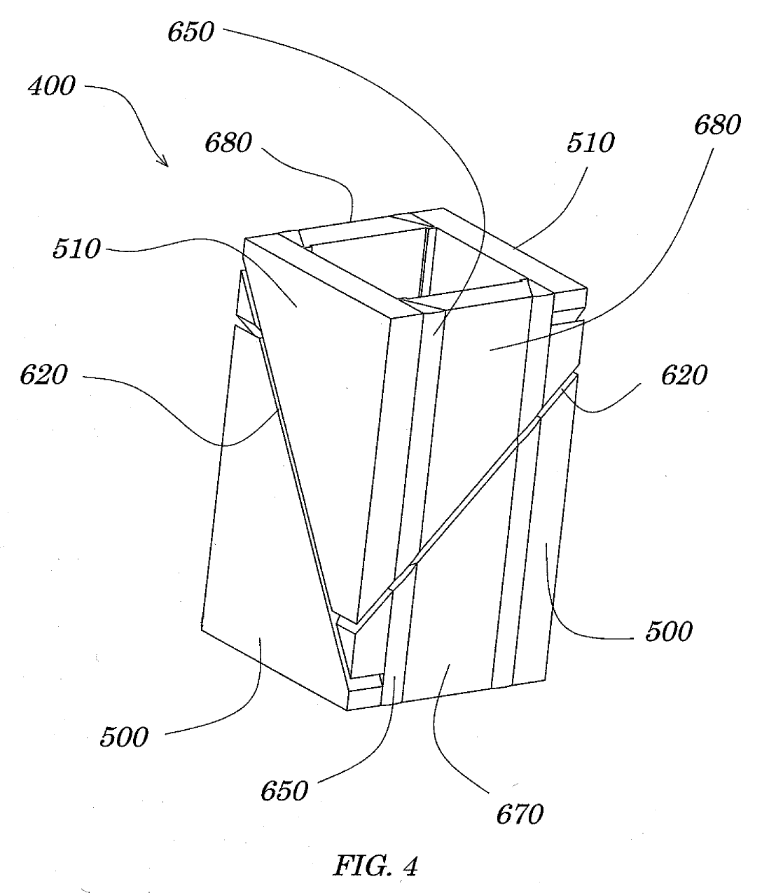

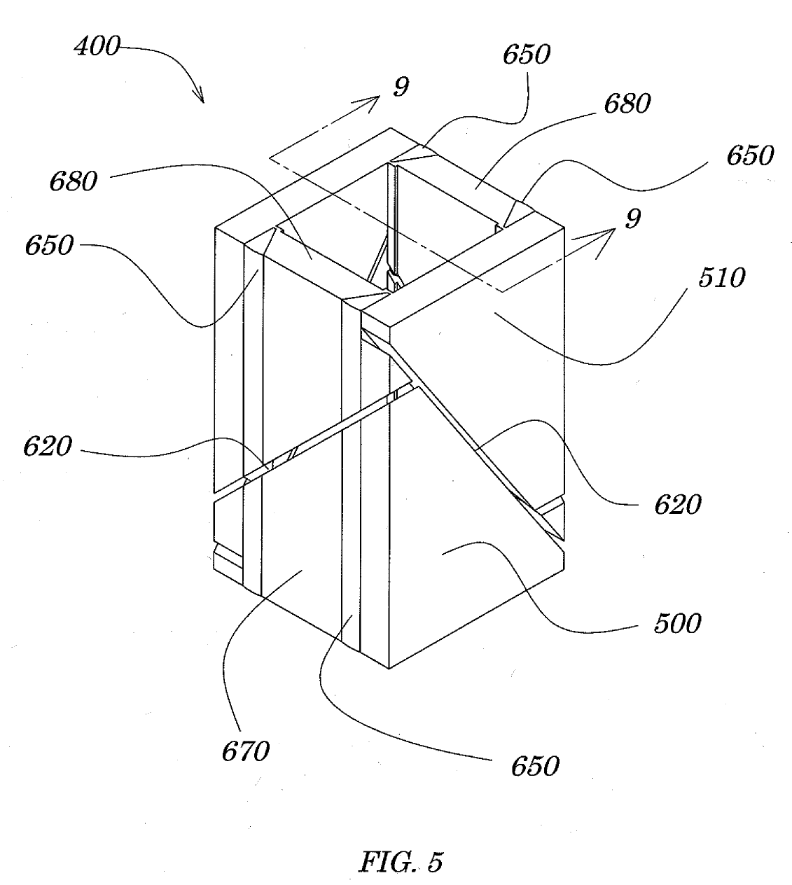

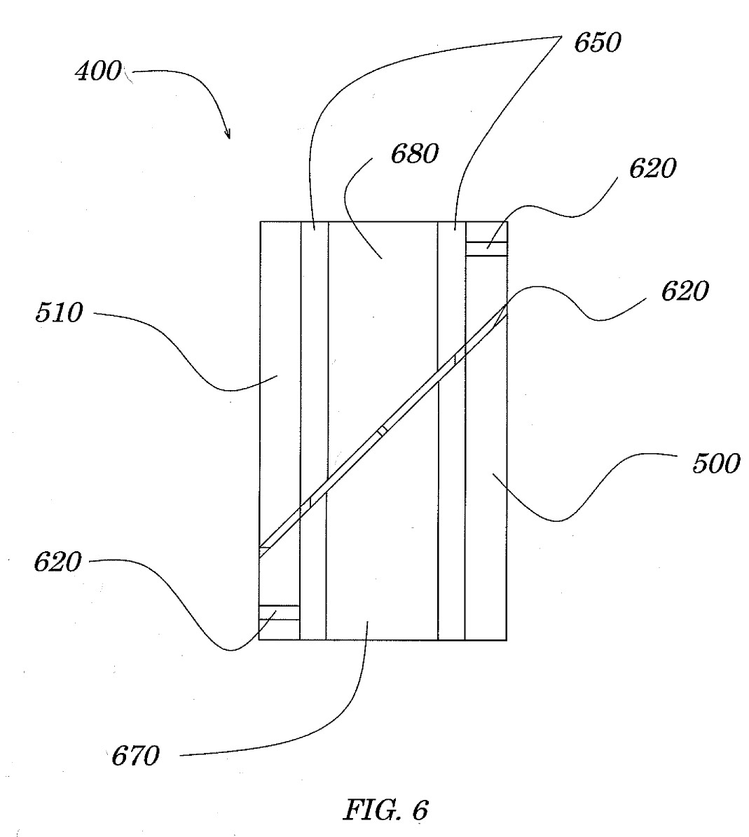

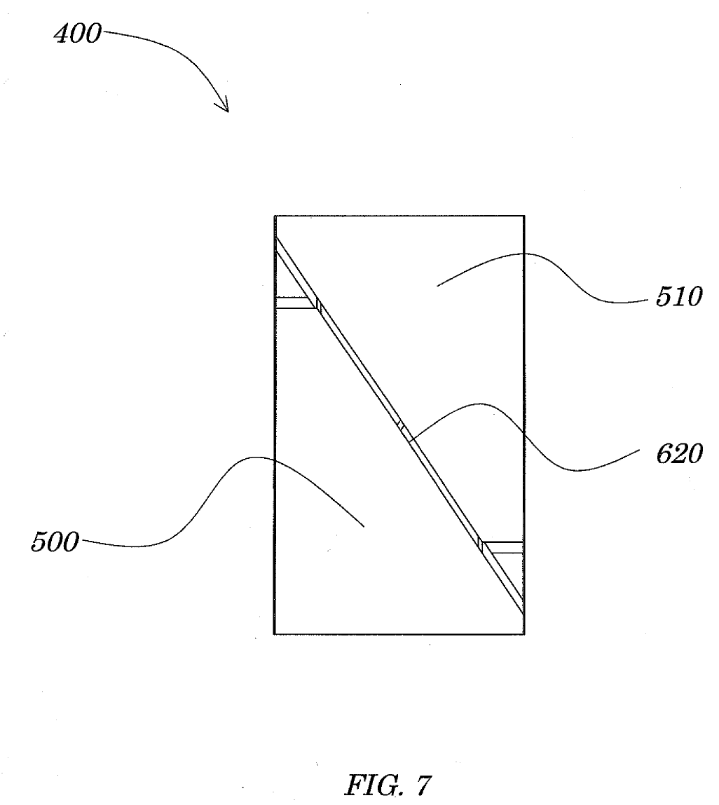

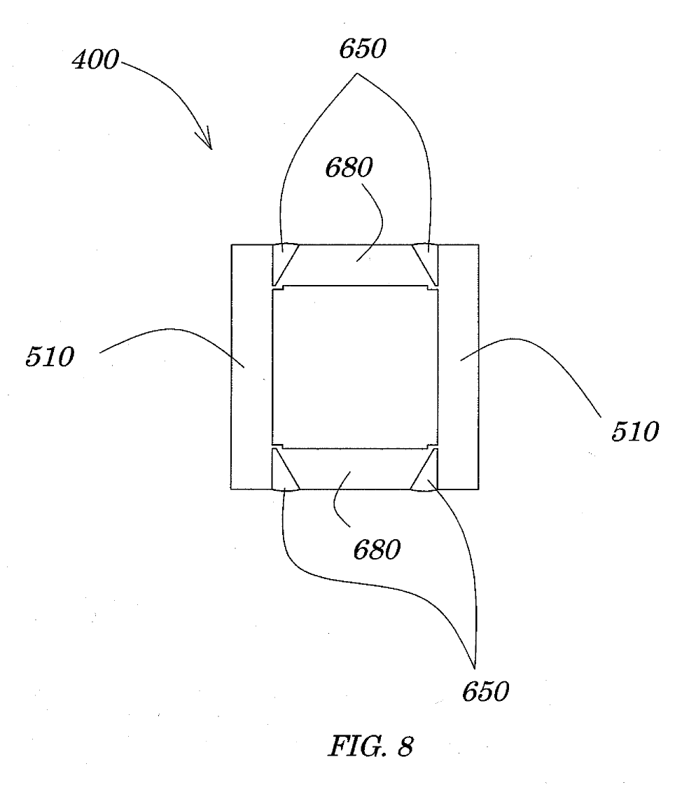

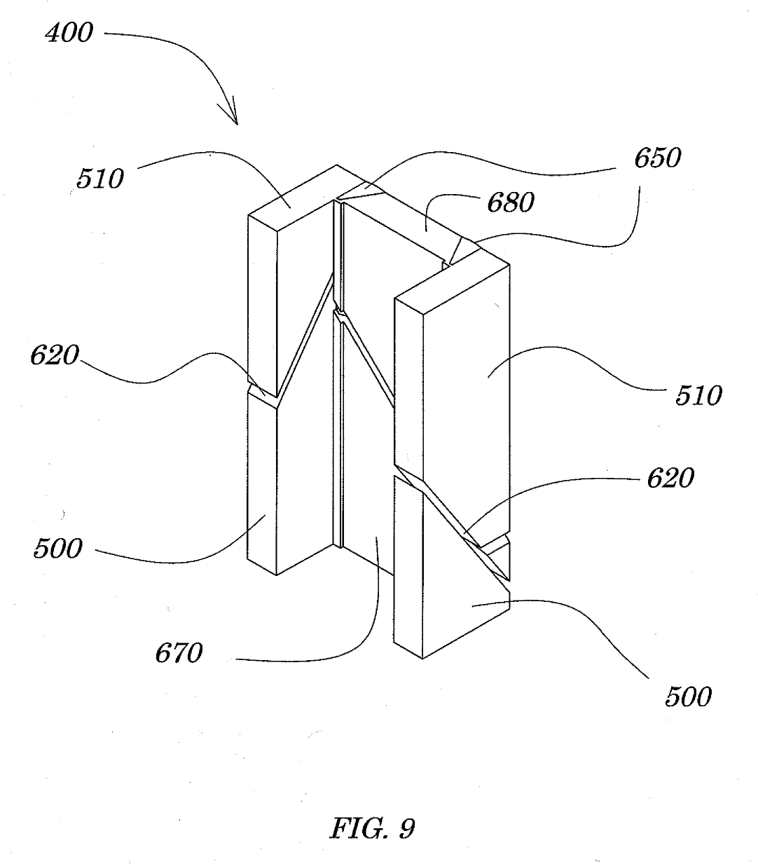

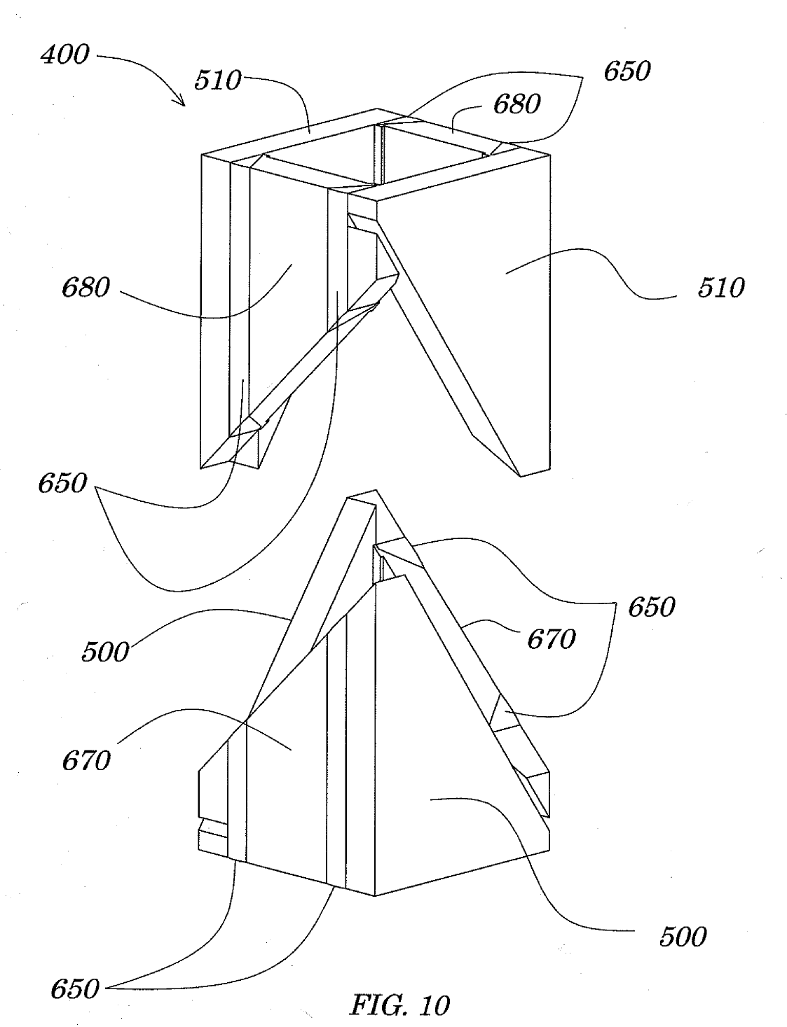

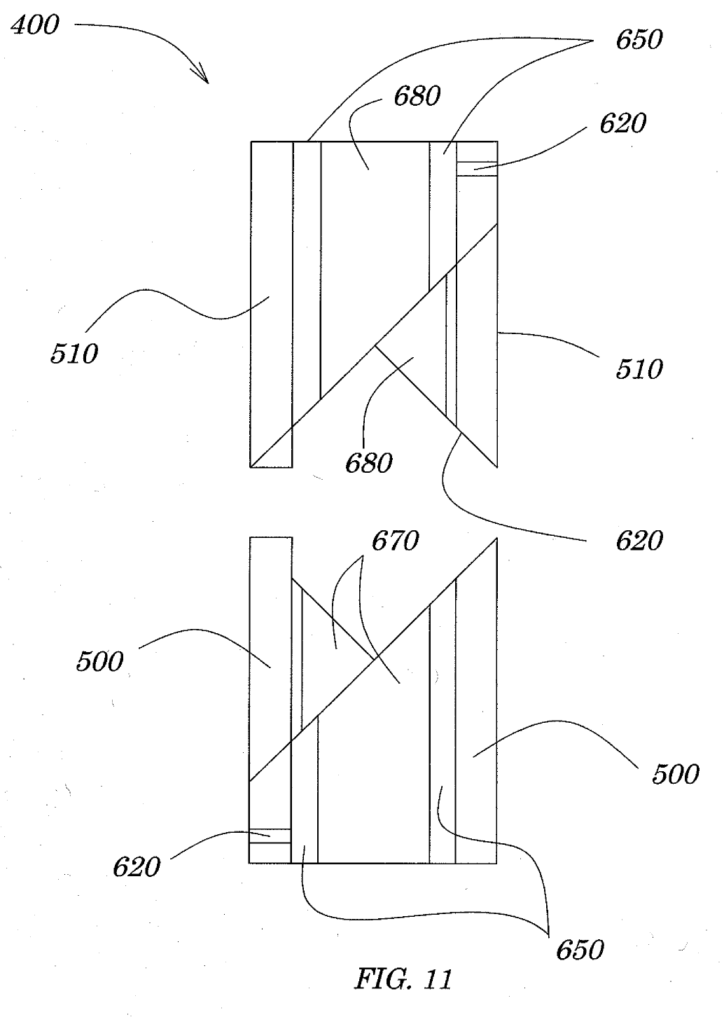

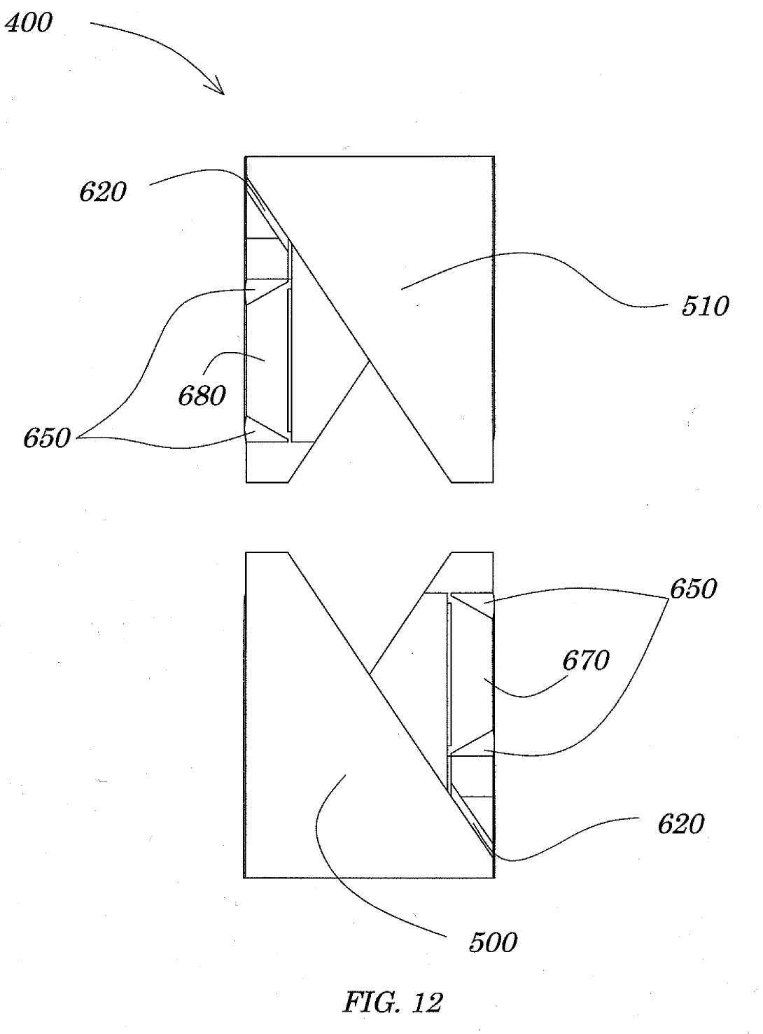

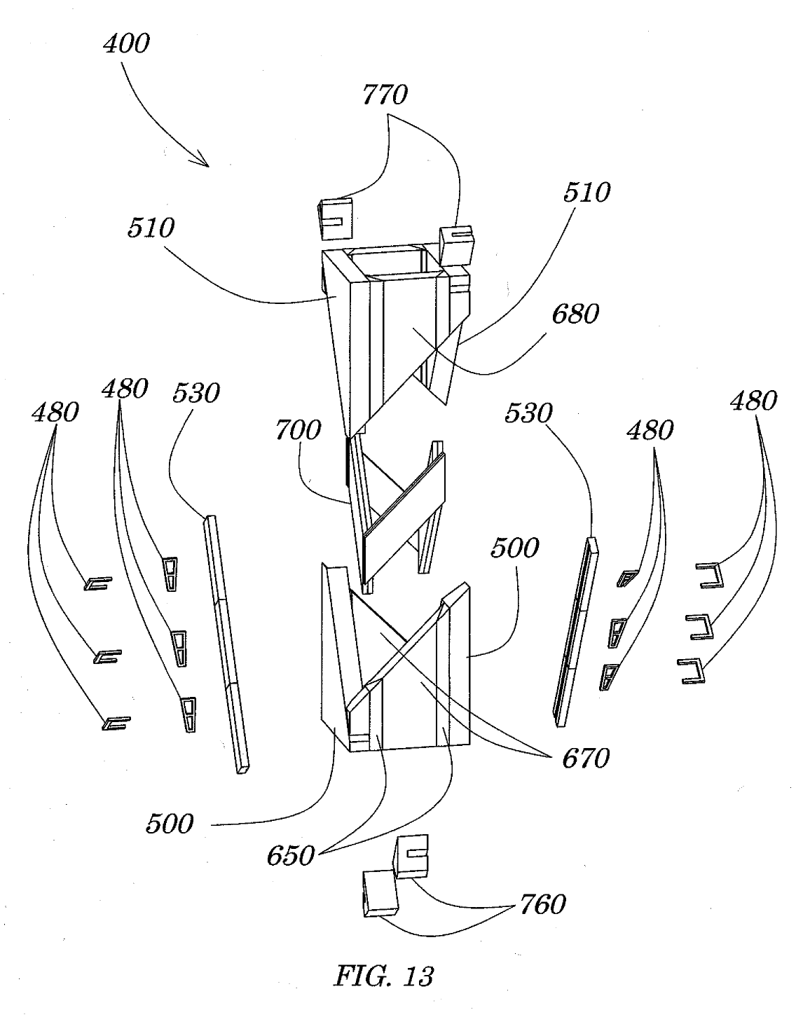

Referring more specifically to the drawings, for illustrative purposes the VertaSlag™ (electroslag) welding system and method used in structures with unlimited multiple floor levels is embodied generally in FIGS. 1-13. It will be appreciated that the system may vary as to configuration and as to the details of the parts, and that the method of using the system may vary as to details and to the order of steps, without departing from the basic concepts as disclosed herein. The system and method for electroslag welding are disclosed generally in terms of welding vertical box columns, as this particular type of welding operation is widely used. However, the disclosed system and method may be used in a large variety of welding applications, as will be readily apparent to those skilled in the art.

Referring to the drawings, the entire length of the two spliced box columns are not shown for clarity. Instead, only the spliced box column ends are depicted, and it will be recognized by those skilled in the art that each spliced box column between the bottom floor and the top floor consist of at least two spliced box column sections.

Referring now to FIGS. 1-13, box columns are generally fabricated in a separate shop environment and are composed of two longitudinal flange plates, 500 and 510, approximately 20 feet long) and two longitudinal web plates, 670 and 680, (approximately 20 feet long) welded together by four longitudinal welds 650. The acute angles on the top and bottom of the box columns of an embodiment of the system and method are also prepared in the shop environment. The prefabricated box columns are then shipped to the job site for joining together to erect the building with the welding system 400 and method described herein. The welding process is used to join two 20 foot prefabricated box columns together. When the top box column is placed into position on top of the bottom box column for an embodiment of the system and method, four VertaSlag™ (electroslag) welding joints are formed (at a 45-degree angle to the vertical). Two opposing joints are used to join the upper and lower flange plates together. After these two opposing plates are joined with the 45-degree VertaSlag™ welding process, the two web plates, 670 and 680, are welded together. After these four plates are welded, the box column is splicing operation is considered complete. The welding system 400 is first used to weld the two aligned box column flange ends 500 and 510. The process is first used to weld the vertically aligned box column workpiece end 500 to 510. The two aligned box column flange ends are brought together so that a gap 620 exists between each pair of workpieces. The system 400 comprises at least one stationary welding fixture 412 positioned to weld 620, as depicted in FIG. 1 for the spliced box column. The fixture further comprises one steel backup shoe 530 on the inside of each weld cavity 620 which are placed on the inside surface of each gap 620 to form the inside surface of the weld cavity. Air-Cooled, or water-cooled copper shoes 530 are placed on the outside surface of weld gap 620 to form the forth and final surface of the VertaSlag™ weld cavity 640 having a center line 642 between the paired workpieces and the welding shoes 530. As such, the welding fixture 412 is thus configured to symmetrically position the welding shoes 530 about the welding cavity center line 642 such that each pair of welding shoes 530 has a bottom portion and a top portion relative to the gap 620. A sump 760 encloses the bottom portion of the welding shoes 530. A run-off tab 770 encloses the top portion of the welding shoes 530.

Each pair of vertical box column workpieces, 500 and 510, to be spliced and 660 and 670 include internal plate steel backup bars 700, to maintain vertical alignment of the box column workpiece pairs, box column flange ends, 500 and 510, and web plates, 670 and 680, until the welding process is completed, in the same manner and arrangement as depicted for system 400 in FIGS. 1-13.

A welding torch 780 is configured to receive at least one consumable guide tube which is placed into each welding cavity 640. The welding torch 780 is coupled to the welding fixture adjacent to each center line and is connected to apparatus for oscillating the welding torch about the center line within each welding cavity 640. The apparatus for oscillating the welding torch about the center line within each welding cavity 640 includes assembly for longitudinally translating the linear actuators along the shafts, assembly for sensing movement of the linear actuators; and a protective housing for enclosing the shafts, motor, and lead screw mechanism that drive the actuator cover plate.

An embodiment of the system provides a gap 620 oriented at a forty-five degree angle between paired vertical box column flange workpieces, 500 and 510 and column web workpieces 660 and 680.

Another embodiment of the system further includes at least one distributed control system 200 and a plurality of control modules 210 according to U.S. Letters Pat. Nos. 6,297,472 and 7,038,154, and pending U.S. Non-provisional Utility patent application Ser. Nos. 10/731,141, 11/591,1907 and 12/212,019, which are herein incorporated, whereby each welding fixture 412 is associated with at least one movable portable platform to carry the wire feeders and welding wire from building column-to column, and using the wire feeder to pull wire from the wire source and push the wire down a flexible conduit assemblies to the welding torch assembly, down the consumable guide tube to the welding puddle.

A further embodiment of the system includes flux dispensing means 470 according to U.S. Letters Pat. No. 7,148,443 and pending U.S. Non-provisional Utility patent application Ser. Nos. 10/731,141, 11/591,190, and 12/212,019, which are herein incorporated, for providing flux to a welding site adjacent each welding torch.

Another embodiment of the system includes welding shoes 530, with at least one sump 760 for each of the two flange weld cavities 640 and one sump 760 for each of the two web weld cavities 640 adjacent to the bottom portion of each welding shoe 530 pair, and at least one run-off tab 770 adjacent to the top portion of each welding shoe 530 pair. Each pair of welding shoes 530 includes copper having means for temperature control of the shoes. Embodiments of the system include at least one welding shoe pair 530 having the welding shoe temperature controlled by circulating either air or water.

An embodiment of the system includes at least one distributed control system 200. Each distributed control system 200 includes a plurality of controller modules 210 and a common bus connecting each of the plurality of controller modules, wherein each controller module includes at least one operator control panel module.

The preferred embodiment of a welding system, in which at least one pair of vertically aligned box column flange workpieces, 500 and 510, and vertically aligned box column web workpieces, 670 and 680, are brought together so that a forty-five degree angled gap 620 having a gap center line exists between the box column workpieces, 500 and 510, and 670 and 680 comprises: (a) at least one stationary welding fixture 412, each fixture comprising assembly 720 for releasably coupling a pair of opposing welding shoes 530 to at least one workpiece end, whereby the opposing welding copper shoes 530 are placed on the outside of each welding gap and one set of steel backup bars 620 are placed on the inside to form a welding cavity 640 between the workpieces and the shoes, and whereby the coupling assembly 720 further symmetrically positions the welding shoes 530 adjacent the cavity 640; (b) at least one welding torch 780 configured to receive at least one consumable guide tube which is placed into the welding cavity 640, the welding torch coupled to the welding fixture 412 adjacent to each center line; and (c) apparatus comprising: a rotating ball lead screw and nut to drive and move the welding torch within the welding cavity 640 according to U.S. Letters Pat. No. 7,148,443 and pending U.S. Non-provisional Utility patent application Ser. Nos. 10/731,141, 11/591,190, and 12/212,019, which are herein incorporated; first and second linear actuators (not shown) according to U.S. Letters Pat. No. 7,148,443 and pending U.S. Non-provisional Utility patent application Ser. Nos. 10/731,141, 11/591,190, and 12/212,019, which are herein incorporated, the actuators movably mounted on the rotating shafts; means for longitudinally translating the linear actuators along the shafts as the shafts rotate (not shown) according to U.S. Letters Pat. No. 7,148,443 and pending U.S. Non-provisional Utility patent application Ser. Nos. 10/731,141, 11/591,190, and 12/212,019, which are herein incorporated; means for sensing movement of the linear actuators (not shown) according to U.S. Letters Pat. No. 7,148,443 and pending U.S. Non-provisional Utility patent application Ser. Nos. 10/731,141, 11/591,190, and 12/212,019, which are herein incorporated; and protective housing means for enclosing the rotating shafts, the actuators, the longitudinally translating means, and the sensing means, for oscillating each welding torch with the cavity.

The preferred embodiment welding system includes at least one-movable portable platform to carry the wire feeders and welding-wire from building column to column, and using the wire feeder to pull wire from the wire source and push the wire down a flexible conduit assemblies to the welding torch assembly, down the consumable guide tube to the welding puddle.

Yet another embodiment of the system further comprises at least one welding wire (not shown) according to U.S. Letters Pat. No. 7,148,443 and pending U.S. Non-provisional Utility patent application Ser. No. 11/202,020, which are herein incorporated. The welding wire includes a metal core wire with metal powder chemistry in the core of the wire to form the correct chemistry for the weld to have sufficient physical strength to meet or exceed any and all of the applicable welding codes for this type of welding operation.

A more detailed description of the consumable guide system is provided in U.S. Letters Pat. No. 7,148,443 and pending U.S. Non-provisional Utility patent application Ser. No. 11/591,190, which both are hereby incorporated by reference.

The preferred embodiment welding system further includes at least one flux dispenser 470, each flux dispenser including: a hopper (not shown) according to U.S. Letters Pat. No. 7,148,443 and pending U.S. Non-provisional Utility patent application Ser. No. 11/202,020, which are herein incorporated; a rotating belt positioned below the hopper (not shown) according to U.S. Letters Pat. No. 7,148,443 and pending U.S. Non-provisional Utility patent application Ser. Nos. 10/731,141, 11/591,190, and 12/212,019, which are herein incorporated; a belt block (not shown) according to U.S. Letters Pat. No. 7,148,443 and pending U.S. Non-provisional Utility patent application Ser. Nos. 10/731,141, 11/591,190, and 12/212,019, which are herein incorporated, and having a recessed area housing the rotating belt; and at least one drop tube (not shown) according to U.S. Letters Pat. No. 7,148,443 and pending U.S. Non-provisional Utility patent application Ser. Nos. 10/731,141, 11/591,190, and 12/212,019, which are herein incorporated, and associated with a lower portion of the recessed area.

The preferred embodiment welding system further includes at least one welding shoe bottom clamping assembly comprising: at least one strong back 480; first and second pairs of welding shoes 530; assembly for positionally adjusting the first pair of welding shoes relative to each other; means for positionally adjusting the second pair of welding shoes relative to each other; and assembly for positionally adjusting the first pair of welding shoes relatively to the second pair of welding shoes.

The preferred embodiment welding system further includes a distributed control system 200, the distributed control system includes a plurality of control modules 210, FIG. 1, with at least one of the control modules comprising an operator control module and a bus connecting the plurality of control modules. The distributed control system 200 and control modules 210 further include at least one assembly for programming and carrying out the operations of: 1) reading control parameter input from a user, the control parameters comprising welding arc voltage, welding arc current, oscillator motion, and welding wire feed rate; 2) controlling welding arc voltage during an automated weld cycle; 3) controlling welding arc current during the automated weld cycle; 4) controlling oscillator motion of the welding torch during the automated weld cycle; 5) controlling flux dispensing in response to the welding arc voltage and the welding arc current during the automated weld cycle; and 6) controlling welding wire feed rate during the automated weld cycle. The distributed control system 200 further includes an oscillator controller module, a wire feed controller module, and a welding power supply controller module.

The method of electroslag welding at least two vertical metal substrates or box column workpieces, 500 and 510, and corresponding web members, 670 and 680, having inside and outside surfaces used in structures with unlimited multiple floor levels includes the steps of:
providing a welding fixture 412, the welding fixture being stationary and including assembly for releasably coupling to at least one vertical metal substrate, the welding fixture including at least one pair of opposing welding shoes 530, assembly for symmetrically positioning the welding shoes about a center line, a welding torch 780, and a consumable guide tube adjacent to the center line;
positioning first and second vertical metal substrates, 500 and 510, and 670 and 680, adjacent to each other, one above the other, with a gap 620 between the first and second substrates; attaching the welding fixture to at least one of the vertical metal substrates, the welding fixture 412 positioned with the center line located adjacent the gap 620 between the substrates, 500 and 510 and 670 and 680; positionally adjusting the opposing welding shoes 530 of the welding fixture 412 relative to the center line to define a welding cavity 640 between the welding shoes 530 and the substrates, 500 and 510 and 670 and 680, the guide tube and the center line positioned within the welding cavity 640; and
filling the welding cavity 640 with molten metal to form Electroslag welds 660 connecting the top and bottom substrates, 500 and 510 and 670 and 680.

The method of electroslag welding at least two vertical metal substrates or box column workpieces, 500 and 510 and 670 and 680, having inside and outside surfaces used in structures with unlimited multiple floor levels further includes the step of:
feeding welding wire through the welding torch and consumable guide tube.

The method of electroslag welding at least two vertical metal substrates or box column workpieces, 500 and 510 and 670 and 680, having inside and outside surfaces used in structures with unlimited multiple floor levels further includes the step of:
oscillating the consumable guide tube and the welding wire within the weld cavity.

An embodiment of this method of electroslag welding at least two vertical metal substrates or box column workpieces, 500 and 510 and 670 and 680, having inside and outside surfaces for use in structures with unlimited multiple floor levels the first substrate 500 and 670 includes a vertically aligned box column having top surfaces angled 45 degrees to a horizontal plane perpendicular to the first substrate alignment and the second substrate 510 and 680 includes a vertically aligned box column having bottom surfaces angled 45 degrees to a horizontal plane perpendicular to the second substrate alignment, such that the first substrate top surface and the second substrate bottom surface define gaps 620 between the box column substrate members, 500 and 510 and 670 and 680.

The method of electroslag welding at least two vertical metal substrates or box column workpiece members, 500 and 510, and 670 and 680, having inside and outside surfaces useful in structures with unlimited multiple floor levels includes the step of:
providing at least one welded steel backup bar 700 connecting the substrate inside surfaces.

The method of electroslag welding at least two vertical metal substrates having inside and outside surfaces useful in structures with unlimited multiple floor levels further includes the step of:
attaching a welding shoe clamping assembly to the connected substrates, 500 and 510 and 670 and 680, the welding shoe clamping assembly comprising strong backs 480 and an assembly for releasably coupling welding shoes 720: first and second pairs of welding shoes 530; means for positionally adjusting the first pair of welding shoes relative to each other; means for positionally adjusting the second pair of welding shoes relative to each other; and means for positionally adjusting the first pair of welding shoes relatively to the second pair of welding shoes.

A more detailed description of the modular distributed control system is provided in U.S. Letters Pat. No. 7,038,159 and pending U.S. Non-provisional Utility patent application Ser. No. 10/731,414, now U.S. Letters Pat. No. 7,429,716, all of which are hereby incorporated by reference.

With respect to the above description then, it is to be realized that the optimum dimensional relationships for the components of the invention, to include variations in size, materials, shape, form, function and manner of operation, assembly, manufacture, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Additionally, since numerous modifications and changes will readily occur to those skilled in the art, it is not desired to limit the invention to the exact construction and operation shown and described, and further, all suitable modifications and equivalents may be resorted to, falling within the scope of the invention.

I claim:

1. A welding system for electroslag welding of spliced vertical box columns in which at least one first vertically aligned workpiece and at least one second vertically aligned workpiece are brought together so that a gap exists between the pair of vertically aligned workpieces, the system comprising:
(a) at least one stationary welding fixture positioned to releasably couple with at least one of the vertically aligned workpieces, the fixture further comprising at least one pair of opposing welding shoes which are placed on each side of each gap to form at least one welding cavity having a center line between each of the paired vertically aligned workpieces and the welding shoes, the welding fixture configured to symmetrically position the welding shoes about the welding cavity center line such that each pair of welding shoes have a bottom portion and a top portion relative to the gap;
(b) a welding torch configured to receive at least one consumable guide tube which is placed into the welding cavity, the welding torch coupled to the welding fixture adjacent to each center line;
(c) means for moving the welding torch about the center line within each cavity;
(d) a first assembly means affixed to the workpieces to hold them together so that an installation apparatus can be removed; and
(e) a second assembly means affixed to the workpieces to hold them in place until the welding process is completed.

2. The system of claim 1, wherein the gap is oriented at an acute angle between each of the paired vertically aligned workpieces.

3. The system of claim 1, further comprising at least one-movable portable platform to carry the wire feeders and welding-wire from building column to column, and using the wire feeder to pull wire from the wire source and push the wire down a flexible conduit assemblies to the welding torch assembly, down the consumable guide tube to the welding puddle.

4. The system of claim 1, further comprising at least one welding wire.

5. The system of claim 1, further comprising flux dispensing means for providing flux to a welding site adjacent each welding torch.

6. The system of claim 1, wherein each pair of welding shoes comprises an outside copper member and an inside steel member.

7. The system of claim 1, further comprising at least one distributed control system, each distributed control system comprising a plurality of controller modules and a common bus connecting each of the plurality of controller modules, wherein each controller module comprises at least one operator control panel module.

8. The system of claim 1, wherein each pair of welding shoes comprises at least one sump adjacent to the bottom portion.

9. The system of claim 1, wherein each pair of welding shoes comprises at least one run-off tab adjacent to the top portion.

10. The system of claim 1, wherein each pair of workpieces comprises means for vertical alignment until the welding process is completed.

11. The system of claim 1, wherein each pair of welding shoes comprises temperature control means for the shoes comprising either water or air circulation.

12. A welding system in which at least one pair of vertically aligned spliced box-column workpieces are brought together so that a forty-five degree angled gap having a gap center line exists between the workpieces, the system comprising:
(a) at least one stationary welding fixture, each fixture comprising means for releasably coupling to at least one workpiece, a pair of opposing welding shoes placed on each side of the gap to form a welding cavity between the workpieces the shoes, and means for symmetrically positioning the welding shoes adjacent the cavity;
(b) at least one welding torch configured to receive at least one consumable guide tube which is placed into the welding cavity, the welding torch coupled to the welding fixture adjacent to each center line;
(c) means for moving each welding torch with the cavity;
(d) a first assembly means affixed to the workpieces to hold them together so that an installation apparatus can be removed; and
(e) a second assembly means affixed to the workpieces to hold them in place until the welding process is completed.

13. The system of claim 12, further comprising at least one movable portable platform to carry the wire feeders and welding-wire from building column to column, and using the wire feeder to pull wire from the wire source and push the wire down a flexible conduit assemblies to the welding torch assembly, down the consumable guide tube to the welding puddle.

14. The system of claim 12, wherein means for moving each welding torch within the cavity:
(a) means for longitudinally translating linear actuators along shafts;
(b) means for sensing movement of the linear actuators; and
(c) protective housing means for enclosing the shafts, a motor, and a lead screw mechanism that drives the actuator cover plate.

15. The system of claim 12, further comprising a welding wire, the welding wire including a metal core wire with metal powder chemistry in the core of the wire to form the correct chemistry for the weld to have sufficient physical strength to meet or exceed any and all of the applicable welding codes for this type of welding operation.

16. The system of claim 12, further comprising at least one flux dispenser, each flux dispenser comprising:
(a) a hopper;
(b) a rotating belt positioned below the hopper; and
(c) at least one drop tube associated with a lower portion of the recessed area.

17. The system of claim 12, further comprising at least one welding shoe bottom clamping assembly, each clamping assembly comprising:
(a) first and second pairs of welding shoes;
(b) means for positionally adjusting the first pair of welding shoes relative to each other;
(c) means for positionally adjusting the second pair of welding shoes relative to each other; and
(d) means for positionally adjusting the first pair of welding shoes relative to the second pair of welding shoes.

18. The system of claim 12, further comprising a distributed control system, the distributed control system comprising:
(a) a plurality of control modules, at least one of the control modules comprising an operator control module; and
(b) a bus connecting the plurality of control modules.

19. The system of claim 18, wherein the distributed control system further comprises programming means for carrying out the operations of:
(a) reading control parameter input from a user, the control parameters comprising welding arc voltage, welding arc current, oscillator motion, and welding wire feed rate;
(b) controlling welding arc voltage during an automated weld cycle;
(c) controlling welding arc current during the automated weld cycle;
(d) controlling oscillator motion of the welding torch during the automated weld cycle;
(e) controlling flux dispensing in response to the welding arc voltage and the welding arc current during the automated weld cycle; and
(f) controlling welding wire feed rate during the automated weld cycle.

20. The system of claim 19, wherein the distributed control system comprises a welding torch motion controller module, a wire feed controller module, and a welding power supply controller module.

21. The system of claim 17, wherein each pair of welding shoes comprises an outside copper member and an inside steel member.

22. A method for electroslag welding at least two vertical metal substrates having inside and outside surfaces, the method comprising the steps of:
(a) providing a welding fixture, the welding fixture being stationary and including means for releasably coupling to at least one vertical metal substrate, the welding fixture including at least one pair of opposing welding shoes, means for symmetrically positioning the welding shoes about a center line, a welding torch, and a consumable guide tube adjacent to the center line;
(b) providing installation apparatus to assemble and position the metal substrates,
(c) positioning a first vertical metal substrate and a second vertical metal substrate adjacent to each other, one above the other, so that the substrates are aligned with a gap between the first and second substrates;
(d) bolting a splicing plate to each of vertically aligned the substrates to hold them together so installation apparatus can be removed;
(e) attaching the welding fixture to at least one of the vertical metal substrates, the welding fixture positioned with the center line located adjacent the gap between the substrates;
(f) positionally adjusting the opposing welding shoes of the welding fixture relative to the center line to define a welding cavity between the welding shoes and the substrates, the guide tube and the center line positioned within the welding cavity; and
(g) filling the weld cavity with molten metal to form a weld connecting the substrates.

23. The method of claim 22, further comprising the step of feeding welding wire through the welding torch and consumable guide tube.

24. The method of claim 23, further comprising the step of oscillating the consumable guide tube and the welding wire within the weld cavity.

25. The method of claim 24, wherein the first substrate comprises a vertically aligned box column having a top surface angled 45 degrees to a horizontal plane perpendicular to the first substrate alignment and the second substrate comprises a vertically aligned box column having a bottom surface angled 45 degrees to a horizontal plane perpendicular to the second substrate alignment, such that the first substrate top surface and the second substrate bottom surface define the gap between the substrates.

26. The method of claim 25, further comprising the step of providing at least one welded strongback connecting the substrate inside surfaces.

27. The method of claim 26, further comprising the step of attaching a welding shoe clamping assembly to the connected substrates, the welding shoe clamping assembly comprising:
(a) first and second pairs of welding shoes;
(b) means for positionally adjusting the first pair of welding shoes relative to each other;
(c) means for positionally adjusting the second pair of welding shoes relative to each other; and
(d) means for positionally adjusting the first pair of welding shoes relative to the second pair of welding shoes.
